(19) United States
(12) Patent Application Publication
(10) Pub. No.: US 2017/0310536 A1
(43) Pub. Date: Oct. 26, 2017

(54) SYSTEMS, METHODS, AND DEVICES FOR NETWORK ALARM MONITORING

(71) Applicant: MARTELLO TECHNOLOGIES CORPORATION, Ottawa (CA)

(72) Inventors: Douglas BELLINGER, Ottawa (CA); Christopher Karl WILSON, Ottawa (CA)

(21) Appl. No.: 15/491,389

(22) Filed: Apr. 19, 2017

Related U.S. Application Data
(60) Provisional application No. 62/325,126, filed on Apr. 20, 2016.

(51) Int. Cl. H04L 12/24

(52) U.S. Cl. CPC H04L 41/069; H04L 41/0609

(57) ABSTRACT

Network devices are monitored and alarms are received from the network devices. An indication of a selected alarm may be received through a user interface. A total distance between the selected alarm and a target alarm of the received alarms is computed. The total distance is computed based on alarm dimensions between the selected alarm and the target alarm. An indication of the target alarm with an indication of the total distance is generated and may out outputted.

### CROSS-REFERENCE TO RELATED APPLICATIONS

This application claims the benefit of U.S. 62/325,126, filed Apr. 20, 2016, the entirety of which is incorporated herein by reference.

### FIELD

This disclosure relates to computers and networks.

### BACKGROUND

Network monitoring involves outputting alarms to network operators to allow operators to troubleshoot and optimize the operations of a computer network.

Alarms are often outputted in a list that an operator can sort and filter to find alarms that need attention. However, it is often the case that the list grows large and that a large number of alarms are ignored or filtered out based on operator experience and other factors. This can cause important alarms to be missed or can make the operators' jobs more difficult, which may result in degraded network performance.

### BRIEF DESCRIPTION OF THE DRAWINGS

The drawings illustrate, by way of example only, embodiments of the present disclosure.

FIG. 1 is a system diagram according to an embodiment of the present invention.

FIG. 2 is a schematic diagram of alarm data.

FIG. 3 is a schematic diagram of an alarm user interface.

FIG. 4 is a diagram showing alarm dimensions to determine alarm similarities.

FIG. 5 is a table showing example distances between device types.

FIG. 6 is a schematic diagram of total distance computations.

FIG. 7 is a schematic diagram of user interface showing output of alarms.

FIG. 8 is a schematic diagram of a system for determining network operator affinity.

### DETAILED DESCRIPTION

The present invention provides systems, processes, and other techniques to solve at least one of the problems of the prior art.

The present invention allows an operator to select or define an alarm that is used as a basis to rank or otherwise output other alarms. Alarms that are similar to the one the operator is interested in are brought the attention of the operator. The present invention also identifies affinities among operators based on their past actions in dealing with past alarms and suggests similar new alarms to similar operators. These aspects of the present invention when used separately or in combination can increase productivity of network operators and thereby increase network efficiency and performance.

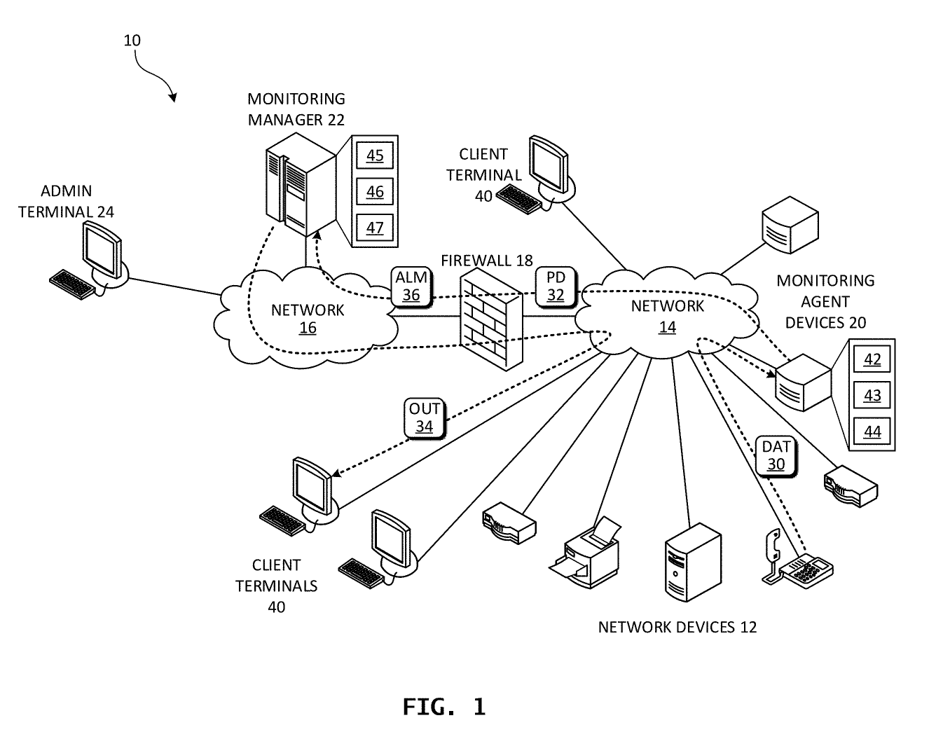

FIG. 1 shows a system 10 according to an embodiment of the present invention. The system 10 is configured to manage the operation of network devices 12 operating within a network 14. The network 14 can include any computer network or combination of networks, such as a local-area network (LAN), an intranet, a wide-area network (WAN), a wireless network, a cellular data network, and similar. Network devices 12 may be termed managed devices and can include any data-enabled electronic devices that communicate via a computer network, such as digital telephones (e.g., Internet protocol, IP, or voice-over IP, VoIP), routers, switches, power sources (e.g., uninterruptable power supplies, UPSs), servers, client computers, load balancers, wireless access points, printers, modems, filters, hubs, bridges, repeaters, audio/video devices (e.g., teleconference devices), unified communications devices, security devices, and similar. The system 10 can operate with any number of distinct networks 14, which are production environments that are contemplated to be controlled by various different parties.

In this embodiment, the system 10 is configured to operate according to the Simple Network Management Protocol (SNMP). In other embodiments, the system 10 can be configured to operate according to other protocols. For sake of illustration, the SNMP will be referenced for various examples discussed herein, but this should not be taken as limiting.

The network 14 is connected to another network 16 via a firewall 18 or similar device. The network 16 can include any computer network or combination of networks, such as a LAN, an intranet, a WAN, a wireless network, a cellular data network, the Internet, and similar. The firewall 18 is configured to prevent unauthorized access to the network 14.

The system 10 includes monitoring agent devices 20 (also termed probes), a monitoring manager 22, and one or more remote administrator terminals 24. The monitoring agent devices 20 receive status and alarm data from associated network devices 12 and report such to the monitoring manager 22, which processes such data for output and/or storage.

The monitoring agent devices 20 are remote data processing devices configured to operate within the network 14. In this embodiment, the monitoring agent devices 20 are SNMP managers configured to monitor the operation of network devices 12 (often termed managed devices in SNMP) by receiving input data 30, such as status data and alarm data, from the network devices 12, which act as sources of input data in a production environment. Input data 30 is sometimes termed a “management information base” or “MIB”. Each monitoring agent device 20 is associated with one or more network devices 12 from which it collects data. Such associations may be created, destroyed, and maintained by the monitoring manager 22 and monitoring agent devices 20. The monitoring agent devices 20 are configured to process input data received from the network devices 12 into processed data 32 for output to the monitoring manager 22. For example, SNMP responses and SNMP Traps are mapped into performance and alarm attributes in the system database. A monitoring agent device 20 may be a computer that has a processor and memory specifically and exclusively configured to operate as an SNMP manager. A monitoring agent device 20 may be plug computer, such as a SheevaPlug device available from Marvell. Alternatively, a monitoring agent device 20 may be a managed network device 12 executing a monitoring agent program. A monitoring agent device 20 may include a processor 42 and memory 43 cooperative to execute instructions 44 to realize functionality discussed herein. Instructions may be stored in a non-transitory computer-readable medium, such as a hard drive, solid-state memory device, flash memory, random-access memory, and the like.

The monitoring manager 22 is connected to the network 16. The monitoring manager 22 is configured to receive processed data 32 from the monitoring agent devices 20 and to format the processed data 32 for output and/or storage as output data 34. The monitoring manager 22 may be further configured to perform further processing, such as normalization and aggregation, on the received processed data 32. In this embodiment, the monitoring agent device 20 is an SNMP manager configured to send SNMP Requests to and receive SNMP Responses and Traps bearing data 30 from the network devices 12. This information is transformed by the monitoring agent device 20 into processed data 32 and sent to the monitoring manager 22. The monitoring manager 22 may include one or more computers which may be termed servers. The monitoring manager 22 may include a processor 45 and memory 46 cooperative to execute instructions 47 to realize functionality discussed herein. Instructions may be stored in a non-transitory computer-readable medium, such as a hard drive, solid-state memory device, flash memory, random-access memory, and the like.

The further processing performed by the monitoring agent 20 on the data 30 received from the network devices 12 may include normalization of network device status data and alarms. For example, a particular router's load may be outputted as an integer and another router's load may be outputted as multiple floating-point values representative of averages over predetermined times. The monitoring agent devices 20 are configured to recognize such values as load metrics, normalize them, and send them to the monitoring manager 22. The monitoring agent device 20 can be configured to normalize the load values to a consistent range, such as a percentage, for output and/or storage. The monitoring manager 22 may be configured to aggregate data from several networks 14.

Client terminals 40 are connected to one or both of the networks 14, 16. The client terminals 40 are configured to connect to the monitoring manager 22 to display output data provided by the monitoring manager 22. Client terminals 40 may be used by administrators of the network 14 to monitor the network's operations, performance, and health.

Communications among the monitoring manager 22, the monitoring agent devices 20, and the terminals 24, 40 can be facilitated by various protocols and techniques, including Transmission Control Protocol/Internet Protocol (TCP/IP), Secure Sockets Layer (SSL), Secure Shell (SSH), SSH tunneling, a Virtual Private Network (VPN), a combination of any of such, and similar. Establishing and maintaining associations between the monitoring agent devices 20 and the network devices 12, as well as communications there-between, can also be achieved using available techniques.

In operation, during monitoring of one or more networks 14, status and/or alarm data from network devices 12 is collected by associated monitoring agent devices 20. Each monitoring agent device 20 processes collected data and sends processed data to the monitoring manager 22, which formats the processed data for display and/or storage as output data. Administrators of the networks 14 can monitor the operation, performance, and health of their networks 14 by using client terminals 40 to connect to the monitoring manager 22 to view and/or download the output data.

When a monitoring agent device 20 detects an alarm or an alarm condition in data 30 received from a network device 12, the monitoring agent device 20 outputs an alarm 36 to the monitoring manager 22. The alarm 36 may be included in processed data 32 or may be a separate entity.

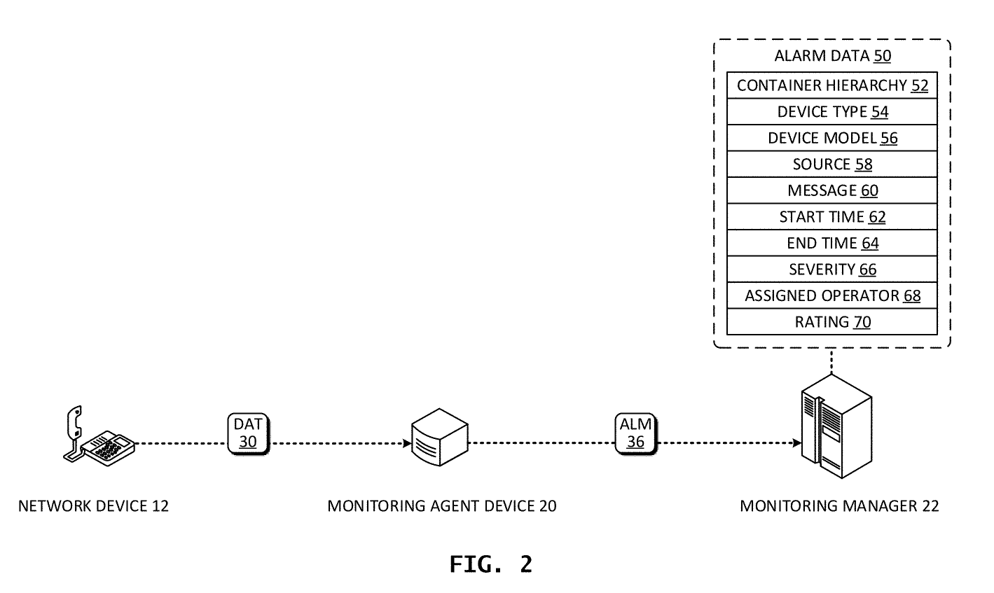

With reference to FIG. 2, the alarm 36 is represented by alarm data 50 that describes the character of the alarm, such as location in a container hierarchy 52 of the network device 12 originating the alarm, the type 54 of network device originating the alarm, a model 56 (e.g., brand, name, manufacturer, model name/number, etc.) of the network device originating the alarm, a source 58 (equipment or service as reported by the network device 12) of the alarm, a message 60 (e.g., a text description) of the alarm, a start time 62 of the alarm, an end time 64 of the alarm, a severity 66 of the alarm, an assigned network operator 68 for the alarm, a rating 70 of the alarm, and/or similar. The various elements 52-70 of alarm data 50 may originate from the data 30 provided by the network device 12, may originate from or be generated by the monitoring agent device 20 raising the alarm 36, may be generated or refined by the monitoring manager 22, or may be the result of a combination of such. That is, for example, a network device 12 indicates a certain element of data, which triggers an alarm at the associated monitoring agent device 20. The monitoring agent device 20 then includes a message based on the element of data in the alarm 36 that is sent to the monitoring manager for display at the monitoring manager 22, which assigns a network operator and ranking to the alarm.

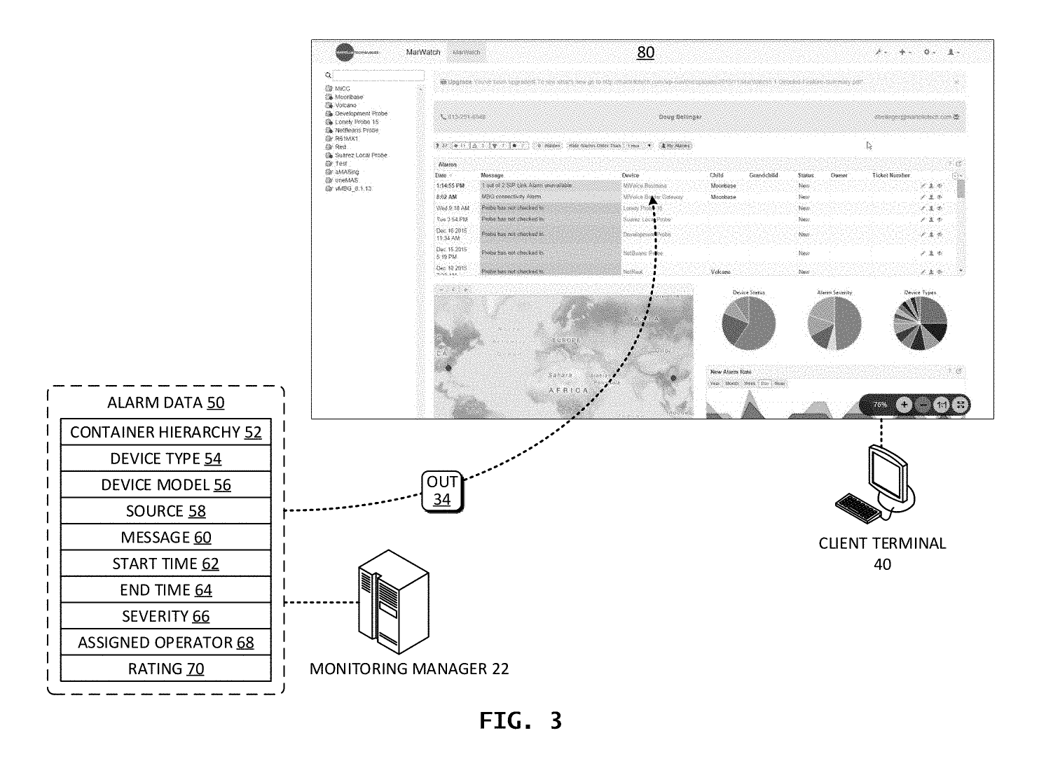

As shown in FIG. 3, alarm data 50 can be outputted by the monitoring manager 22 to a client terminal 40, as output data 34, for presentation in a user interface 80 of the client terminal 40. The user interface 80 is configured to allow selection of any alarm, whether an actual alarm or a template alarm, for use as the basis for evaluating other alarms. Selection can include selecting an alarm from a ranked list, entry of template alarm characteristics, and similar. The selected alarm forms the basis for output of other alarms. A network operator may select an alarm as the basis for which he or she wishes to see similar alarms.

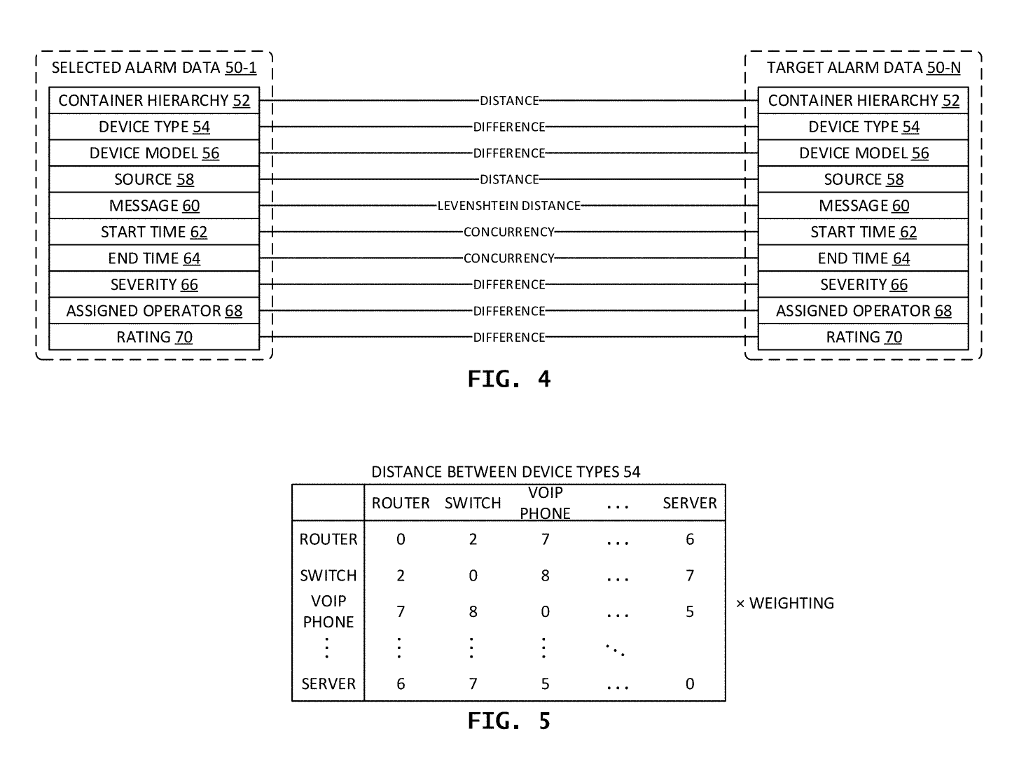

As shown in FIG. 4, a selected alarm is compared to one or more target alarms. Target alarms can include existing alarms and newly received alarms. Target alarms may also be filtered based on operator preference. A total distance between a selected alarm's data 50-1 and a target alarm's data 50-N is computed based on alarm dimensions defined between the selected alarm and the target alarm. Alarm dimensions represent similarities between data elements 52-70 of alarm data.

Example alarm dimensions include a distance in a container hierarchy 52 between a network device 12 originating the selected alarm and a network device 12 originating the target alarm, a difference in a type 54 of network device 12 originating the selected alarm and a type 54 of network device 12 originating the target alarm, a difference between a model 56 of network device 12 originating the selected alarm and a model 56 of network device 12 originating the target alarm, a difference between a source 58 of the selected alarm and a source 58 of the target alarm, a Levenshtein distance (textual difference) between a message 60 of the selected alarm and a message 60 of the target alarm, a concurrency in a start time 62 of the selected alarm and a start time 62 of the target alarm, a concurrency in an end time 64 of the selected alarm and an end time 64 of the target alarm, a difference in a severity 66 of the selected alarm and a severity 66 of the target alarm, a difference in an assigned network operator 68 for the selected alarm and an assigned network operator 68 of the target alarm, and a difference in a rating 70 of the selected alarm and a rating 70 of the target alarm. Other examples are also contemplated.

Computing a value for each alarm dimension being considered can use any suitable methodology. An example for device type 54 is shown in FIG. 5. A lookup table (or matrix) is prepopulated with difference values and takes device type 54 of the selected alarm (column) and device type 54 of the target alarm (row) to obtain a difference value between the device types 54 being compared. In this example, a greater value equates to a greater difference between device types.

Similar methodologies are used for each alarm dimension considered. A consistent sense is used among methodologies, such as higher values equating to greater differences, greater distances, and lesser degrees of concurrency.

Further, each alarm dimension can be assigned a weighting. Computing the total distance between the selected alarm's data 50-1 and a target alarm's data 50-N can thus include computing a weighted sum of all alarm dimensions. If weightings are not used, a simple sum can be computed instead.

The values for various alarm dimensions and weightings can be made configurable via the user interface so that customized similarity computations can be developed.

The monitoring engine can include a computation engine for determining the total distances and an alarm output engine for generating the user interface or otherwise outputting alarms based on computed total distance.

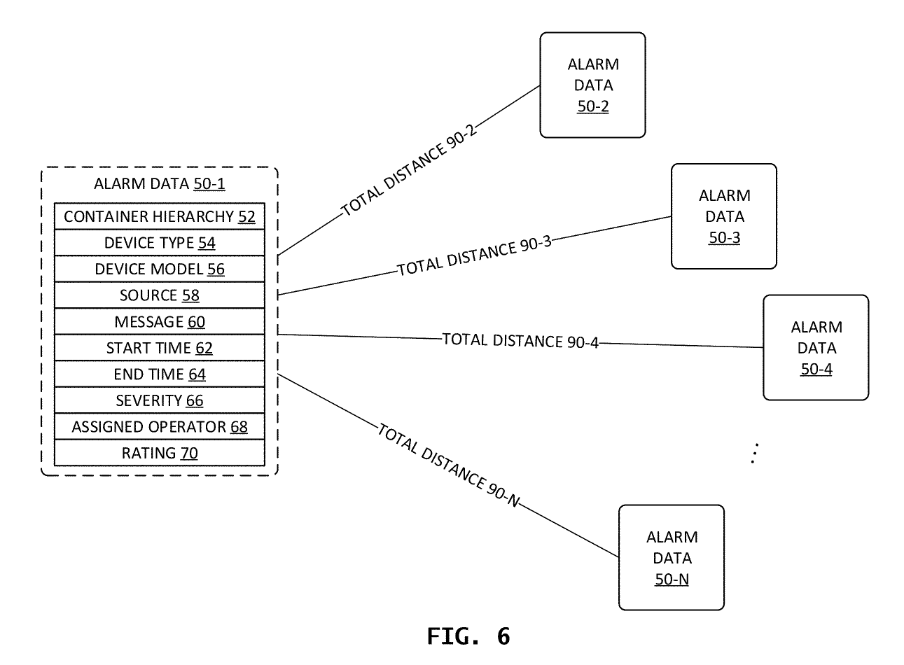

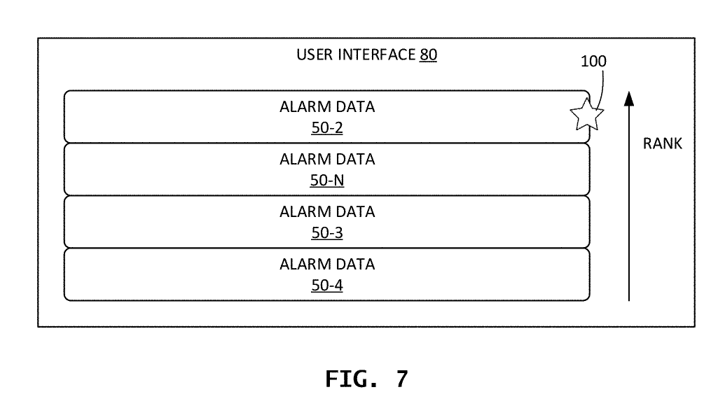

As shown in FIG. 6, a total distance 90-2, 90-3, 90-4, 90-N can be individually computed for each of a many target alarms 50-2, 50-3, 50-4, 50-N. Indications of target alarms and their total distances can then be generated and outputted.

For instance, as shown in FIG. 7, target alarm data can be presented in the user interface in a ranked order based on total distance, with alarms more similar to the selected alarm being ranked higher. Not all target alarms need be displayed and not every data element 52-70 need be displayed. Additionally or alternatively, an icon or other visual indicator 100 can be presented for alarms that have a total distance that contravenes a threshold distance, which may be made user-configurable. Additionally or alternatively, alphanumeric ratings can be assigned to alarms based on the computed total distance and displayed at the user interface 80.

The computed total distances can also be compared to one or more threshold distances, which may be made user-configurable, to trigger additional actions beyond outputting indications of the alarms. Such actions include assigning a network operator to an alarm, transmitting a notification to a network operator, transmitting a query to the network device that triggered the alarm, and similar.

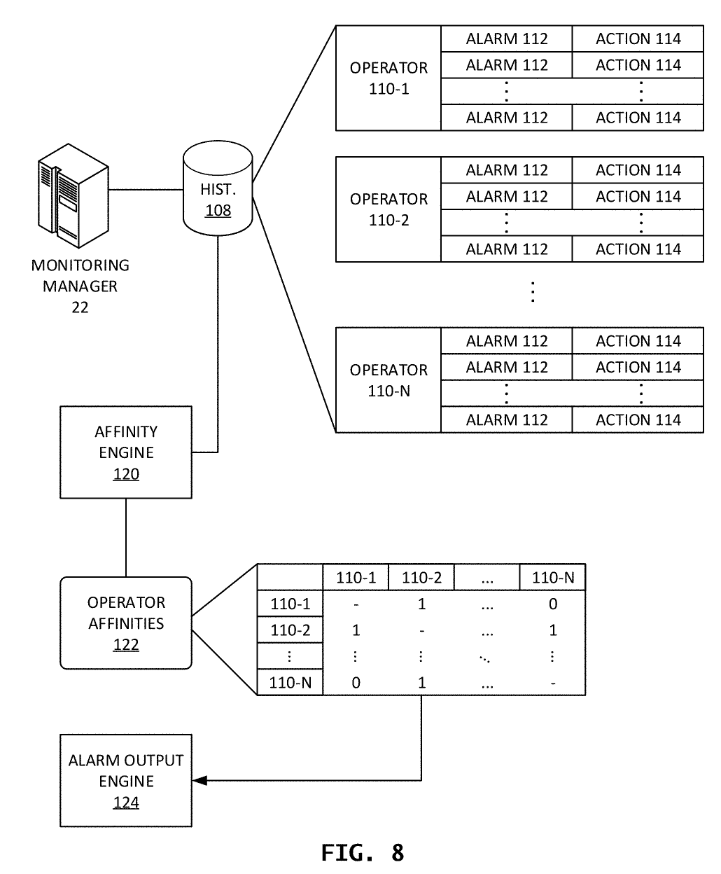

As shown in FIG. 8, the monitoring manager 22 can store historical alarm data 108, including past alarms 112 and various actions 114 taken by various network operators 110-1, 110-2, 110-N (generally 110). Each network operator 110 is associated with multiple past alarms 112 and each past alarm 112 can be associated with multiple actions 114. Past alarms 112 are defined by alarm data 50 discussed above. Actions 114 can include marking the alarm as completed (i.e., the underlying network problem was fixed), ignoring the alarm, assigning the alarm to another operator, and the like. Actions 114 are indicated to the monitoring manager 22 by a network operator via the user interface 80, described above.

The set of past alarms 112 and undertaken actions 114 for each operator 110 in a sense defines that operator's job, at least historically. That is, each network operator's preferences, behaviour, and duties can be elicited from the historical alarm data 118.

The monitoring manager 22 can include an affinity engine 120 that is configured to process historical alarm data 108 to obtain statistical operator affinity data 122 that identifies similar network operators. In this way, similarities between network operators can be determined and can be used when assigning new alarms. Operators who have worked on similar alarms can be assigned similar alarms in the future.

The affinity engine 120 is configured to compute statistical affinities in historical alarm data 108 using operator identifier (e.g., ID number, email address, name) as the basis. Any suitable statistical methodology can be used. The result is statistical operator affinity data 122 that, in one example, identifies similar operators. The table shown in FIG. 8 contains a “1” if the operators in the row and column are determined to be similar and a “0” if not. In other examples, other values can be used for finer gradations of operator affinity.

In the statistical computation, similar alarms can be identified as described above in relation to the alarm dimensions. Similar actions can be defined by a lookup table (or matrix). In one example, similar actions are identical actions. In one example computation, each alarm 112 for each operator 110 is compared to each other alarm 112 of the other operators 110, the comparison yielding a total distance (discussed above), or other measure of similarity, between each pair of compared alarms 112. Then, for each pair of compared alarms 112, the actions 114 taken are compared and the total distance, or other measure of similarity, is refined. In one example, the same action 114 preserves the total distance, or other measure of similarity, while different actions nullify the total distance, or other measure of similarity. That is, an operator who ignores a certain type of alarm will determined to be less similar to an operator who completes the same type of alarm. Finally, a total affinity is computed for all pairs of compared alarms 112 and actions 114 for each pair of operators 110 by, for example, summing the total distances, or other measure of similarity. The statistical operator affinity data 122 can then obtained as the computed total affinity for each pair of operators 110, an indication of such affinity (e.g., “1” or “0”, as shown in the table) if the total affinity passes a threshold affinity, or similar.

The historical data 108 used when computing operator affinity can be limited by age, so that alarms and actions older than a specific age (e.g., 1 year) are not considered or are weighted less than newer alarms and actions. This allows operator affinity to degrade with age, so that, for example, network operators whose jobs diverge for other reasons cease seeing similar alarms.

The monitoring manager 22 can include an alarm output engine 124 that references the statistical operator affinity data 122 when outputting new alarms. Among operators that have historical affinity, actions taken on new alarms are tracked and similar new alarms are outputted to such operators and being alarms of potential interest. That is, considering a first network operator and a second network operator, based on a statistical affinity between the first and second operators, a new second alarm for the second network operator is selected after the first network operator has taken action on a new first alarm that is similar to the new second alarm. Groups of similar operators can thus be dynamically defined and continually updated based on past alarms and actions, and new alarms that are taken up by a group member cause similar new alarms to be promoted to other group members. The alarm output engine 124 can be configured to identify similar alarms using the techniques discussed herein (e.g., total distance).

In another illustrative example, if two operators are determined to have historic affinity because they both complete router alarms consistently and then one of the operators begins completing VoIP telephone alarms, then the alarm output engine 124 will begin to recommend VoIP telephone alarms to the other operator. This illustrates how the present invention allows operators with similar behaviour to learn from each other.

The alarm output engine 124 can be configured to output a list of alarms for each operator and rank alarms higher in the list when affinity is determined. Other techniques to bring such alarms to the attention of operators, such as icons and ratings, can additionally or alternatively be used.

As discussed above, the present invention has at least several advantages over the prior art. Alarms having greater relevance can be brought the attention of network operators using machine intelligence and learning in an adaptive and dynamic manner.

While the foregoing provides certain non-limiting example embodiments, it should be understood that combinations, subsets, and variations of the foregoing are contemplated. The monopoly sought is defined by the claims.

What is claimed is:

1. A process for outputting a network monitoring alarm, the process comprising:
monitoring a plurality of network devices;
receiving a plurality of alarms from the plurality of network devices;
at a user interface, receiving an indication of a selected alarm of the plurality of alarms;
computing a total distance between the selected alarm and a target alarm of the plurality of alarms, the total distance being computed based on a plurality of alarm dimensions between the selected alarm and the target alarm; and
outputting an indication of the target alarm with an indication of the total distance.

2. The process of claim 1, wherein outputting the indication of the target alarm comprises outputting a ranked list of alarms including the target alarm, an order of the ranked list being based on the total distance.

3. The process of claim 1, further comprising comparing the total distance to a threshold distance, and wherein outputting the indication of the target alarm includes triggering an action when the total distance contravenes the threshold distance.

4. The process of claim 1, comprising computing a plurality of total distances between the selected alarm and a plurality of target alarms and outputting indications of at least some of the plurality of target alarms with indications of respective total distances.

5. The process of claim 1, wherein each alarm dimension of the plurality of alarm dimensions represents a comparison of a characteristic of the selected alarm with the characteristic of the target alarm.

6. The process of claim 5, wherein computing the total distance comprises computing weighted sums for the plurality of alarm dimensions.

7. The process of claim 5, wherein the plurality of alarm dimensions comprises two or more of:
a distance in a container hierarchy between a network device originating the selected alarm and a network device originating the target alarm;
a difference in a type of network device originating the selected alarm and a type of network device originating the target alarm;
a difference between a model of network device originating the selected alarm and a model of network device originating the target alarm;
a difference between a source of the selected alarm and a source of the target alarm;
a Levenshtein distance between a message of the selected alarm and a message of the target alarm;
a concurrency in a start time of the selected alarm and a start time of the target alarm;
a concurrency in an end time of the selected alarm and an end time of the target alarm;
a difference in a severity of the selected alarm and a severity of the target alarm;
a difference in an assigned network operator for the selected alarm and an assigned network operator of the target alarm; and
a difference in a rating of the selected alarm and a rating of the target alarm.

8. A process for outputting a network monitoring alarm, the process comprising:
monitoring a plurality of network devices;
obtaining a plurality of sets of historical alarms and actions, including past alarms and actions taken by a plurality of network operators in response to past alarms;
computing statistical affinities among the plurality of sets of historical alarms and actions;
receiving a plurality of alarms from the plurality of network devices; and
for a first network operator and a second network operator of the plurality of network operators, based on a statistical affinity between the sets of historical alarms and actions for the first network operator and the second network operator, selecting a new second alarm for the second network operator after the first network operator has taken action on a new first alarm that is similar to the new second alarm; and
outputting an indication of the new second alarm to the second operator.

9. The process of claim 8, wherein computing the statistical affinities comprises computing distinct statistical affinities for different network device types and different alarm times.

10. A system for outputting a network monitoring alarm, the system comprising:
memory and;
a processor to execute instructions to:
receive a plurality of alarms from a plurality of network devices;
receive an indication of a selected alarm of the plurality of alarms;
compute a total distance between the selected alarm and a target alarm of the plurality of alarms, the total distance being computed based on a plurality of alarm dimensions between the selected alarm and the target alarm; and
generate an indication of the target alarm with an indication of the total distance.

11. The system of claim 10, wherein the instructions are further to output a ranked list of alarms including the target alarm, an order of the ranked list being based on the total distance.

12. The system of claim 10, wherein the instructions are further to compare the total distance to a threshold distance and trigger an action when the total distance contravenes the threshold distance.

13. The system of claim 10, wherein the instructions are further to compute a plurality of total distances between the selected alarm and a plurality of target alarms and generate indications of at least some of the plurality of target alarms with indications of respective total distances.

14. The system of claim 10, wherein each alarm dimension of the plurality of alarm dimensions represents a comparison of a characteristic of the selected alarm with the characteristic of the target alarm.

15. The system of claim 14, wherein the instructions are further to compute the total distance by computing weighted sums for the plurality of alarm dimensions.

16. The system of claim 14, wherein the plurality of alarm dimensions comprises two or more of:
a distance in a container hierarchy between a network device originating the selected alarm and a network device originating the target alarm;
a difference in a type of network device originating the selected alarm and a type of network device originating the target alarm;
a difference between a model of network device originating the selected alarm and a model of network device originating the target alarm;
a difference between a source of the selected alarm and a source of the target alarm;
a Levenshtein distance between a message of the selected alarm and a message of the target alarm;
a concurrency in a start time of the selected alarm and a start time of the target alarm;
a concurrency in an end time of the selected alarm and an end time of the target alarm;
a difference in a severity of the selected alarm and a severity of the target alarm;
a difference in an assigned network operator for the selected alarm and an assigned network operator of the target alarm; and
a difference in a rating of the selected alarm and a rating of the target alarm.
